(19) United States
(12) Patent Application Publication
(10) Pub. No.: US 2026/0081152 A1
(43) Pub. Date: Mar. 19, 2026

(54) ELECTROCHEMICAL STACK, CELL PACK, AND METHODS OF USING ELECTROCHEMICAL STACK AND CELL PACK

(71) Applicant: Violet Chia-Chen Wu LIN, Rolling Hills, CA (US)

(72) Inventor: Violet Chia-Chen Wu LIN, Rolling Hills, CA (US)

(21) Appl. No.: 18/888,163

(22) Filed: Sep. 18, 2024

(51) Int. Cl. H01M 4/58; H01M 4/02; H01M 4/62; H01M 4/66; H01M 50/103

(52) U.S. Cl. CPC H01M 4/5825; H01M 4/623; H01M 4/625; H01M 4/661; H01M 50/103; H01M 2004/021

(57) ABSTRACT

The present disclosure concerns rechargeable batteries (i.e., secondary batteries) having large form factors that include cathode active materials such as, but not limited to, lithium iron phosphate (LFP) active material, lithium manganese iron phosphate (LMFP) active material, or a combination thereof. Also disclosed herein are methods of using the same and processes for making the same.

### BACKGROUND

### Field of the Invention

The present disclosure concerns rechargeable batteries (i.e., secondary batteries) having large form factors that include cathode active materials such as, but not limited to, lithium iron phosphate (LFP) active material, lithium manganese iron phosphate (LMFP) active material, or a combination thereof.

### Description of Related Art

A rechargeable battery includes three basic components, a cathode, an anode, and an electrolyte therebetween. There are currently a variety of cathode materials suitable for use in rechargeable lithium ion batteries. These includes lithium cobalt oxides, e.g., LiCoO₂, lithium nickel manganese cobalt oxides, e.g., LiNiMnCo₂, lithium nickel cobalt aluminum oxides, e.g., LiNiCoAlO₂, lithium manganese oxides, e.g., LiMnO₄, and lithium iron phosphates, e.g., LiFePO₄ and LiMnFePO₄ (herein LFP and LMFP, respectively).

The aforementioned nickel and cobalt oxides (e.g., NMC) are typically associated with higher energy densities than comparable iron phosphates. This means that NMC, for example, is typically able to store more energy per unit volume than LFP. As such, more LFP is needed in a positive electrode than NMC to achieve the same total energy stored.

One problem associated with making a positive electrode large enough to accommodate a sufficient amount of LFP is that the positive electrode, and the battery it is a part of, tends to heat up during use as a consequence of the internal impedance of the LFP electrochemistry.

What is needed are solutions to the aforementioned problem, as well as others in the field to which the instant disclosure pertains. The instant disclosure provides such solutions to this and other problems.

### SUMMARY

In one embodiment, set forth herein is an electrochemical stack in a prismatic can, wherein: the electrochemical stack includes at least one positive electrode that includes lithium iron phosphate (LFP) active material, lithium manganese iron phosphate (LMFP) active material, or a combination thereof; the prismatic can has a positive terminal and a negative terminal on at least one prismatic can face; and the surface area of the positive terminal and the negative terminal is at least 70% of the surface area of the at least one prismatic can face.

In a second embodiment, set forth herein is a method of using an electrochemical stack described herein, or a module or pack described herein, including charging the electrochemical stack to at least 4.1 V.

In a third embodiment, set forth herein is a method of using an electrochemical stack described herein, or a module or pack described herein, including charging the electrochemical stack to less than 4.5 V.

In a fourth embodiment, set forth herein is a module or pack that includes an electrochemical cell described herein.

In a fifth embodiment, set forth herein is an electric vehicle that includes a module or pack set forth herein.

### BRIEF DESCRIPTION OF THE DRAWINGS

FIG. 1 shows a schematic of a prismatic can according to an embodiment described herein.

FIG. 2A shows a schematic of a prismatic can with positive and negative terminals on the same minor face according to an embodiment described herein.

FIG. 2B shows a schematic of a prismatic can with positive and negative terminals on opposite, parallel minor faces, according to an embodiment described herein.

FIG. 3A shows a schematic of a prismatic can with positive and negative terminals on the same minor face according to an embodiment described herein.

FIG. 3B shows a schematic of a prismatic can with positive and negative terminals on opposite, parallel minor faces, according to an embodiment described herein.

FIG. 4A shows a schematic of a prismatic can with positive and negative terminals on the same minor face according to an embodiment described herein.

FIG. 4B shows a schematic of a prismatic can with positive and negative terminals on the same major face according to an embodiment described herein.

FIG. 5A shows a schematic of a prismatic can with positive and negative terminals on the same minor face according to an embodiment described herein.

FIG. 5B shows a schematic of a prismatic can with positive and negative terminals on opposite, parallel major faces, according to an embodiment described herein.

FIG. 6 is a schematic diagram showing the combinations of positive electrodes, electrolytes, and negative electrodes contemplated for use with the instant disclosure, according to certain embodiments.

FIG. 7 shows the performance of Test Electrochemical Cell V (100% of the active material was LFP), which was tested at −10° C., 0° C., 23° C., 45° C., and 60° C.

FIG. 8 shows a plot of Discharge Capacity (mAh) as a function of charge-discharge cycle for Test Electrochemical Cell V.

FIG. 9 shows a plot of Voltage (V) as a function of Discharge Energy (Wh) for Test Electrochemical Cell I (100% of the active material was LMFP; top plot) with comparison to Test Electrochemical Cell V (100% of the active material was LFP; bottom plot).

FIG. 10 shows a plot of Discharge Capacity (mAh) as a function of charge-discharge cycle for electrochemical cells that were charged to a maximum of 4.2 V.

FIG. 11 shows a plot of Discharge Capacity (mAh) as a function of charge-discharge cycle for electrochemical cells that were charged to a maximum of 4.5 V.

FIG. 12 shows the performance of Test Electrochemical Cell 1 (100% of the active material was LMFP), which was tested at −10° C., 0° C., 23° C., 45° C., and 60° C.

FIG. 13 shows the Rate Capability performance of Test Electrochemical Cell I (100% of the active material was LMFP), LMFP64 at 0.5 C, 1 C, 2 C, 3 C, 5 C and 1 C cycle rate.

### DETAILED DESCRIPTION

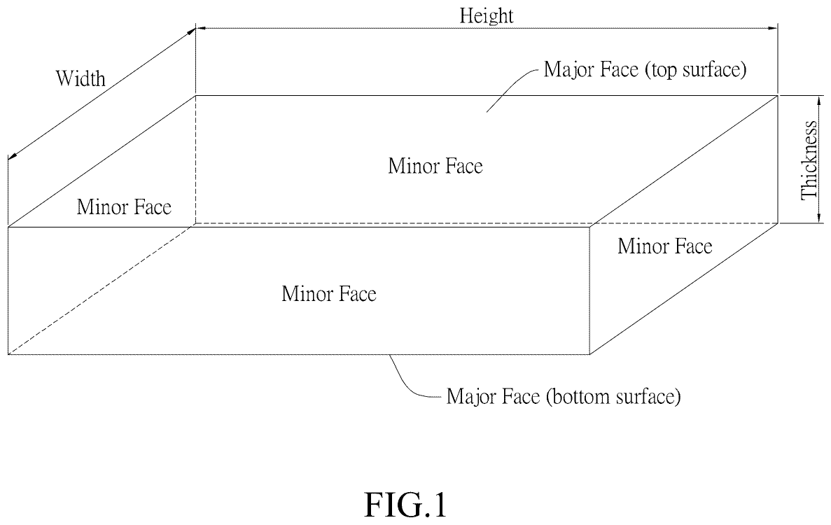

Set forth herein are large form factor rechargeable batteries (i.e., secondary batteries) that include cathode active materials such as, but not limited to, lithium iron phosphate (LFP) active material, lithium manganese iron phosphate (LMFP) active material, or a combination thereof. In certain embodiments, the rechargeable batteries having a prismatic form factor that is at least 80 cm in height or length, at least 25 cm in width, at least 5 cm in thickness, or any combination thereof. In certain of these embodiments, the rechargeable batteries, set forth herein, have a discharge capacity greater than 50 amp-hours (Ah) at C rates of 1 C to 12 C. These batteries include anode (i.e., negative electrode) and cathode (i.e., positive electrode) terminals that cover at least 70% of the surface area of the face of the prismatic can on which the terminals are disposed. See, for example, FIGS. 1-5, as detailed herein and below. The anode terminals may be made of copper (Cu), nickel (Ni), or a combination or alloy of Cu and Ni. The cathode terminals may be made of aluminum (AI). Layers of electrochemical cells may be combined in zigzag, stacking, or rolling configurations. In certain embodiments, the batteries include at least 20 layers of electrochemical cells therein.

### Definitions

As used herein, the phrase “electrochemical stack,” refers to at least two or more electrochemical cells in combination. An electrochemical cell includes a positive electrode (+) (i.e., a cathode), a negative electrode (−) (i.e., an anode), and an electrolyte, optionally with a separator, between the positive electrode and negative electrode. When combining electrochemical cells, a cathode current collector or anode current collector, or both, may be shared with and between adjacent electrodes. For example, an aluminum cathode current collector may be coated on both sides with a cathode slurry. That double-sided coated cathode current collector may be combined with electrolyte, two separators, and two copper anode current collectors, each copper anode current collector coated with an anode slurry, to form a two layered electrochemical cell that includes one, shared aluminum cathode current collector. Also, for example, a copper anode current collector may be coated on both sides with an anode slurry. That double-sided coated anode current collector may be combined with electrolyte, two separators, and two aluminum positive electrode current collectors, each coated with a cathode slurry, to form a two layered electrochemical cell that includes one, shared copper anode current collector. Cathodes and anodes may be combined in a variety of ways known in the art to which the instant disclosure pertains.

As used herein, the phrase “prismatic can,” refers to a rectangular shaped device useful for containing one or more layers of rechargeable electrochemical cells. A prismatic can is shown schematically in FIG. 1. The prismatic can is defined by its largest dimension, the height or also called its length, as illustrated in FIG. 1. The prismatic can also includes a width dimension that is perpendicular to the height dimension, as illustrated in FIG. 1. The prismatic can also include a thickness dimension that is perpendicular to both the height dimension and the width dimension, as illustrated in FIG. 1. The prismatic can, as shown in FIG. 1, includes six faces. The two faces with the largest geometric surface area are the top surface and bottom surface, which are labeled the Major Face (top surface) and Major Face (bottom surface), respectively. Around the edge, there are four minor faces, each perpendicular to the two major faces.

As used herein, the phrase “lithium iron phosphate (LFP) active material,” refers to the cathode active material that includes lithium, iron, phosphorus, and oxygen. LFP is often written as LiFePO₄. LFP may be amorphous or crystalline. LFP may be crystalline and adopts an olivine crystal structure.

As used herein, the phrase “lithium manganese iron phosphate (LMFP) active material,” refers LFP, as defined above, and further including manganese (Mn). The amount of Mn in LMFP may vary. For example, the molar ratio of Mn and Fe may vary according to the formula, LiMnₓFe₁₋ₓPO₄, in which x is 0.1 to 0.9. In LMFP64, the molar ratio of Mn:Fe is 6:4. In LMFP82, the molar ratio of Mn:Fe is 8:2. Herein, LMFP64 refers to LiMn_{0.6}Fe_{0.4}PO₄. Herein, LMFP82 refers to LiMn_{0.8}Fe_{0.2}PO₄.

As used herein, the phrase “positive terminal and a negative terminal,” refers to the conductive ends of a battery through which a current flows during charge and discharge. The positive terminal is on the exterior of a battery and connects to the positive electrode current collectors from each electrochemical layer. The negative terminal is on the exterior of a battery and connects to the negative electrode current collectors from each electrochemical layer. Connecting the exterior positive terminal and negative terminal completes an electrical circuit.

As used herein, the phrase “prismatic can face,” refers to a rigid container for containing two or more electrochemical layers. A prismatic can is schematically shown in FIGS. 1-5.

As used herein, the phrase “surface area of the positive terminal and the negative terminal is at least 70% of the surface area of the at least one prismatic can face,” refers to a comparison of the surface area of the terminals with the surface area of the face or faces of the prismatic can on which the terminals are disposed.

As used herein, the phrase “layers,” refers to one or more layers, in which each layer includes at least one positive electrode, at least one negative electrode, and an electrolyte therebetween. In some embodiments, two adjacent layers share a positive electrode. In some embodiments, two adjacent layers share a negative electrode.

As used herein, the phrase “zig-zag,” refers to a manner of combining electrochemical cell layers in which two webs of positive and negative electrodes are folded one on top of the other in a zigzag fashion.

As used herein, the phrase “layered stack,” refers to a manner of combining electrochemical cell layers in which the layers are placed vertically, one on top of the other. The layers may be connected in series or in parallel. The layers may be connected with shared electrode current collectors.

As used herein, the phrase “rolling format (i.e., jelly-roll),” refers to a manner of combining electrochemical cell layers in which the layers are rolled into a cylindrical format, e.g., an 18650 rechargeable battery can.

As used herein, the phrase “active material loading,” refers to the mass of active material relative to the surface area of the electrode current collector on which the active material is deposited. This value is often represented with the units, m²/g.

As used herein, the phrase “vent,” refers to an opening in a prismatic can through which gas may conduct. In some embodiments, the vent is configured so that gas only conducts through the vent when the gas is at or above a specific pressure. In some embodiments, the vent is used to degas gas that may build up internally in a prismatic can when a battery is used. In some embodiments, the vent is used to draw a vacuum or a reduced pressure inside the prismatic can.

### Electrochemical Stack

In some embodiments, set forth herein is an electrochemical stack in a prismatic can, wherein: the electrochemical stack includes at least one positive electrode that includes lithium iron phosphate (LFP) active material, lithium manganese iron phosphate (LMFP) active material, or a combination thereof; the prismatic can has a positive terminal and a negative terminal on at least one prismatic can face; and the surface area of the positive terminal and the negative terminal is at least 70% of the surface area of the at least one prismatic can face.

In certain embodiments, including any of the foregoing, the particle size of the cathode active material is less than 2 microns (2 μm).

In certain embodiments, including any of the foregoing, the particle size of the cathode active material is about 100 μm.

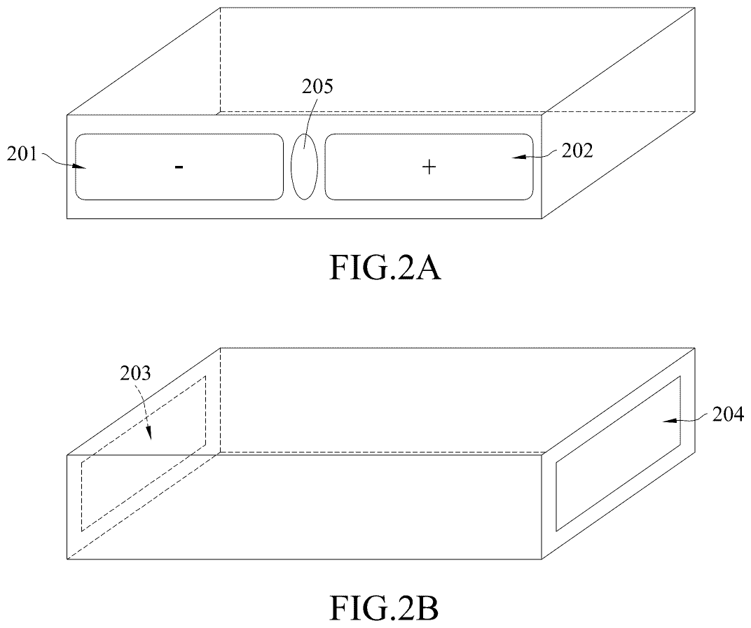

In one embodiment, as shown in FIG. 2A, the positive terminal (201) and the negative terminal (202) are on one of the two larger minor faces. In FIG. 2A, there is a vent 205 shown between the positive terminal (201) and the negative terminal (202). In another embodiment, as shown in FIG. 2B, the positive terminal (203) and the negative terminal (204) are each individually on one of the two smaller minor faces. In FIG. 2B, the positive terminal (203) and the negative terminal (204) are shown on opposite minor faces.

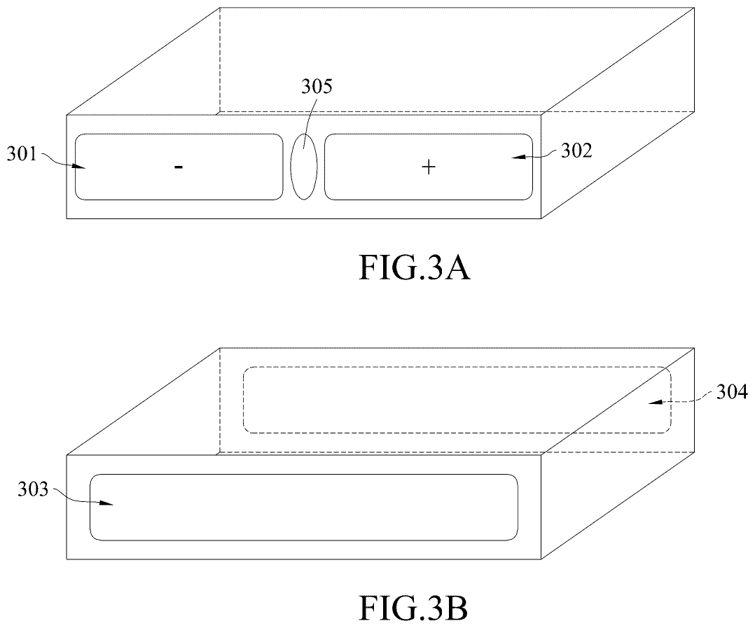

In another embodiment, as shown in FIG. 3A, the positive terminal (301) and the negative terminal (302) are on one of the two larger minor faces. In FIG. 3A, there is a vent 305 shown between the positive terminal (301) and the negative terminal (302). In another embodiment, as shown in FIG. 3B, the positive terminal (303) and the negative terminal (304) are each individually on one of the two larger minor faces. In FIG. 3B, the positive terminal (303) and the negative terminal (304) are shown on opposite minor faces.

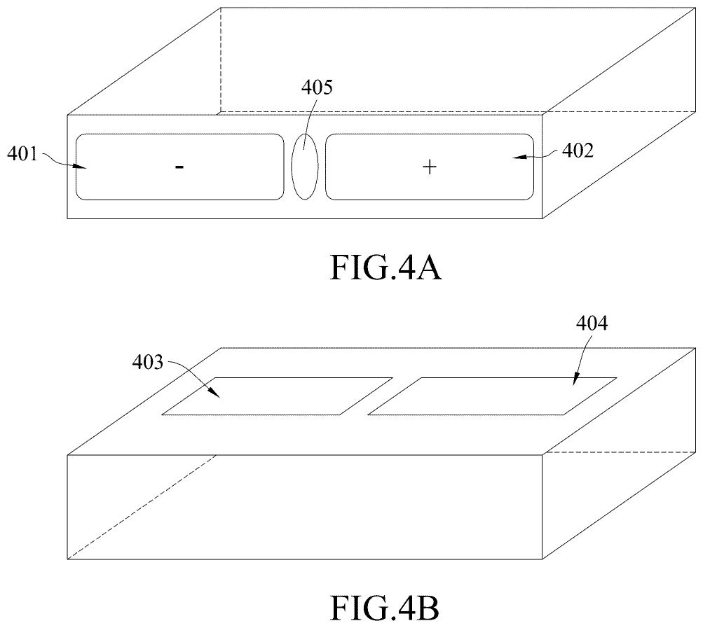

In another embodiment, as shown in FIG. 4A, the positive terminal (401) and the negative terminal (402) are on one of the two larger minor faces. In FIG. 4A, there is a vent 405 shown between the positive terminal (401) and the negative terminal (402). In another embodiment, as shown in FIG. 4B, the positive terminal (403) and the negative terminal (404) are both on the same major face.

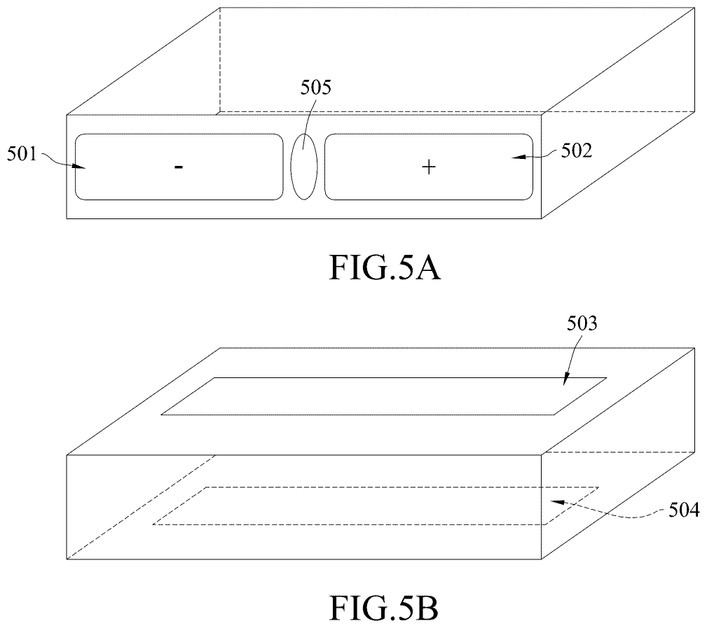

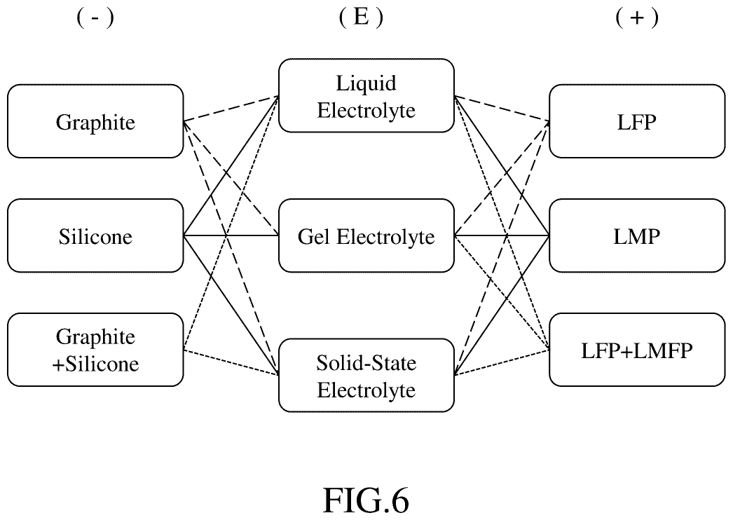

In another embodiment, as shown in FIG. 5A, the positive terminal (501) and the negative terminal (502) are on one of the two larger minor faces. In FIG. 5A, there is a vent 505 shown between the positive terminal (501) and the negative terminal (502). In another embodiment, as shown in FIG. 5B, the positive terminal (503) and the negative terminal (504) are each individually on opposite, parallel major faces.

In some embodiments, including any of the foregoing, the surface area of the positive terminal and the negative terminal is 70% to 80% of the surface area of the at least one prismatic can face on which the positive terminal and the negative terminal are disposed.

In certain embodiments, the surface area of the positive terminal and the negative terminal is 71% of the surface area of the at least one prismatic can face on which the positive terminal and the negative terminal are disposed. In certain embodiments, the surface area of the positive terminal and the negative terminal is 72% of the surface area of the at least one prismatic can face on which the positive terminal and the negative terminal are disposed. In certain embodiments, the surface area of the positive terminal and the negative terminal is 73% of the surface area of the at least one prismatic can face on which the positive terminal and the negative terminal are disposed. In certain embodiments, the surface area of the positive terminal and the negative terminal is 74% of the surface area of the at least one prismatic can face on which the positive terminal and the negative terminal are disposed. In certain embodiments, the surface area of the positive terminal and the negative terminal is 75% of the surface area of the at least one prismatic can face on which the positive terminal and the negative terminal are disposed. In certain embodiments, the surface area of the positive terminal and the negative terminal is 76% of the surface area of the at least one prismatic can face on which the positive terminal and the negative terminal are disposed. In certain embodiments, the surface area of the positive terminal and the negative terminal is 77% of the surface area of the at least one prismatic can face on which the positive terminal and the negative terminal are disposed. In certain embodiments, the surface area of the positive terminal and the negative terminal is 78% of the surface area of the at least one prismatic can face on which the positive terminal and the negative terminal are disposed. In certain embodiments, the surface area of the positive terminal and the negative terminal is 79% of the surface area of the at least one prismatic can face on which the positive terminal and the negative terminal are disposed. In certain embodiments, the surface area of the positive terminal and the negative terminal is 80% of the surface area of the at least one prismatic can face on which the positive terminal and the negative terminal are disposed.

When the positive terminal and negative terminal are on the same prismatic can face, then the positive terminal and negative terminal are at least 70% of the surface of that same prismatic can face.

When the positive terminal and negative terminal are on separate prismatic can faces, then the positive terminal and negative terminal are at least 70% of the surface of that combined surface area of the separate faces.

In some embodiments, including any of the foregoing, the at least one positive electrode includes LFP active material.

In some embodiments, including any of the foregoing, the active material includes LFMP selected from LMFP64. This is LMFP in which the ratio of Mn:Fe is 6:4.

In some embodiments, including any of the foregoing, the active material includes LFMP selected from LMFP82. This is LMFP in which the ratio of Mn:Fe is 8:2.

In some embodiments, including any of the foregoing, the at least one positive electrode includes combinations of LFP active material and LMFP active material.

In some embodiments, including any of the foregoing, the at least one positive electrode includes a carbon additive selected from Super-P, VGCF, carbon nanotubes, single-walled carbon nanotubes, multi-walled carbon nanotubes, graphite, and combinations thereof. In some embodiments, including any of the foregoing, the at least one positive electrode includes a carbon additive selected from Super-P, VGCF, and combinations thereof.

In some embodiments, including any of the foregoing, the weight ratio of LFP:LMFP in the positive electrode is 0.01:100 to 100:0.01

In some embodiments, including any of the foregoing, the weight ratio of LFP:LMFP is 20:80, 30:70, 50:50, 80:20 or 70:30. In some embodiments, including any of the foregoing, the weight ratio of LFP:LMFP is 20:80. In some embodiments, including any of the foregoing, the weight ratio of LFP:LMFP is 30:70. In some embodiments, including any of the foregoing, the weight ratio of LFP:LMFP is 50:50. In some embodiments, including any of the foregoing, the weight ratio of LFP:LMFP is 80:20. In some embodiments, including any of the foregoing, the weight ratio of LFP:LMFP is 70:30.

In some embodiments, including any of the foregoing, the positive terminal and the negative terminal are on the same prismatic can face. For example, the embodiment shown in the top of FIG. 1 and the embodiment shown in the bottom of FIG. 4.

In some embodiments, including any of the foregoing, the positive terminal and the negative terminal are on the top prismatic can face or the bottom prismatic can face. For example, the embodiment shown in the bottom of FIG. 4.

In some embodiments, including any of the foregoing, the positive terminal and the negative terminal are on an edge prismatic can face. Herein, an edge prismatic can face is used interchangeably with minor face. For example, the embodiment shown in the bottom of FIG. 2 and the embodiment shown in the bottom of FIG. 3.

In some embodiments, including any of the foregoing, the positive terminal and the negative terminal are on a different prismatic can face. For example, the embodiment shown in the bottom of FIGS. 2, 3, and 5.

In some embodiments, including any of the foregoing, the positive terminal and the negative terminal are on opposite, parallel faces. For example, the embodiment shown in the bottom of FIGS. 2, 3, and 5.

In some embodiments, including any of the foregoing, the positive terminal is on the top prismatic can face and the negative terminal is on the bottom prismatic can face. For example, the embodiment shown in the bottom of FIG. 5.

In some embodiments, including any of the foregoing, the positive terminal and the negative terminal are on different edge prismatic can faces. For example, the embodiment shown in the bottom of FIGS. 2 and 3.

In some embodiments, including any of the foregoing, the prismatic can height (or length) is at least 80 cm. In certain embodiments, the prismatic can height is less than 100 cm.

In some embodiments, including any of the foregoing, the prismatic can height (or length) is 80 cm.

In some embodiments, including any of the foregoing, the prismatic can height (or length) is 100 cm.

In some embodiments, including any of the foregoing, the prismatic can width is at least 25 cm.

In some embodiments, including any of the foregoing, the prismatic can width is less than 100 cm.

In some embodiments, including any of the foregoing, the prismatic can width is 25 cm.

In some embodiments, including any of the foregoing, the prismatic can thickness is at least 2 cm.

In some embodiments, including any of the foregoing, the prismatic can thickness is at least 5 cm.

In some embodiments, including any of the foregoing, the prismatic can thickness is less than 100 cm.

In some embodiments, including any of the foregoing, the prismatic can thickness is 5 cm.

In some embodiments, including any of the foregoing, the prismatic can thickness is 2 cm to 5 cm.

In some embodiments, including any of the foregoing, the electrochemical stack includes at least one negative electrode selected from the group consisting of graphite, silicon, and graphite-silicon.

In some embodiments, including any of the foregoing, the electrochemical stack includes at least one positive electrode current collector made of aluminum.

In some embodiments, including any of the foregoing, the electrochemical stack includes at least one negative electrode current collector made of a metal selected from a copper (Cu), nickel (Ni), and combinations or alloys of Cu, Ni, or Cu and Ni.

In some embodiments, including any of the foregoing, the electrochemical stack includes at least one electrolyte selected from the group consisting of a liquid electrolyte, a gel electrolyte, a solid-state electrolyte, and combinations thereof. In some embodiments, the positive electrode includes PVDF and an organic solvent. In some embodiments, the organic solvent is NMP. In some embodiments, the solid electrolyte includes mixtures of organic or inorganic compounds.

In some embodiments, including any of the foregoing, the at least one positive electrode further includes carbon additives Super-P.

In some embodiments, including any of the foregoing, the at least one positive electrode further includes carbon additives VGCF.

In some embodiments, including any of the foregoing, the at least one positive electrode further includes PVDF binder.

In some embodiments, including any of the foregoing, the amount of LMFP64 is about 94% by weight of the positive electrode, exclusive of the positive electrode current collector.

In some embodiments, including any of the foregoing, the at least one negative electrode further includes graphite.

In some embodiments, including any of the foregoing, the at least one negative electrode further includes Super-P.

In some embodiments, including any of the foregoing, the at least one negative electrode further includes VGCF.

In some embodiments, including any of the foregoing, the at least one negative electrode further includes PVDF.

In some embodiments, including any of the foregoing, the amount of graphite is about 95% by weight, exclusive of the negative electrode current collector. In certain embodiments, the graphite is MG11.

In some embodiments, including any of the foregoing, the electrochemical stack includes at least twenty layers.

In some embodiments, including any of the foregoing, the electrochemical stack includes 100 layers or less.

In some embodiments, including any of the foregoing, the layers are configured in a zig-zag format, a layered stack format, or a rolling (i.e., jelly-roll) format.

In some embodiments, including any of the foregoing, the active material loading in the at least one positive electrode is at least 5 mg/cm².

In some embodiments, including any of the foregoing, the active material loading in the at least one positive electrode is 5 mg/cm² to 55 mg/cm².

In some embodiments, including any of the foregoing, the active material loading in the at least one positive electrode is 5 mg/cm², 5.5 mg/cm², 6 mg/cm², 6.5 mg/cm², 7 mg/cm², 7.5 mg/cm², 8 mg/cm², 8.5 mg/cm², 9 mg/cm², 9.5 mg/cm², 10 mg/cm², 10.5 mg/cm², 11 mg/cm², 11.5 mg/cm², 12 mg/cm², 12.5 mg/cm², 13 mg/cm², 13.5 mg/cm², 14 mg/cm², 14.5 mg/cm², 15 mg/cm², 15.5 mg/cm², 16.0 mg/cm², 16.5 mg/cm², 17 mg/cm², 17.5 mg/cm², 18 mg/cm², 18.5 mg/cm², 19 mg/cm², 19.5 mg/cm², 20 mg/cm², 20.5 mg/cm², 21 mg/cm², 21.5 mg/cm², 22 mg/cm², 22.5 mg/cm², 23 mg/cm², 23.5 mg/cm², 24 mg/cm², 24.5 mg/cm², 25 mg/cm², 25.5 mg/cm², 26.0 mg/cm², 26.5 mg/cm², 27 mg/cm², 27.5 mg/cm², 28 mg/cm², 28.5 mg/cm², 29 mg/cm², 29.5 mg/cm², 30 mg/cm², 30.5 mg/cm², 31 mg/cm², 31.5 mg/cm², 32 mg/cm², 32.5 mg/cm², 33 mg/cm², 33.5 mg/cm², 34 mg/cm², 34.5 mg/cm², 35 mg/cm², 35.5 mg/cm², 36.0 mg/cm², 36.5 mg/cm², 37 mg/cm², 37.5 mg/cm², 38 mg/cm², 38.5 mg/cm², 39 mg/cm², 39.5 mg/cm², 40 mg/cm², 40.5 mg/cm², 41 mg/cm², 41.5 mg/cm², 42 mg/cm², 42.5 mg/cm², 43 mg/cm², 43.5 mg/cm², 44 mg/cm², 44.5 mg/cm², 45 mg/cm², 45.5 mg/cm², 46.0 mg/cm², 46.5 mg/cm², 47 mg/cm², 47.5 mg/cm², 48 mg/cm², 48.5 mg/cm², 49 mg/cm², 49.5 mg/cm², or 50 mg/cm².

In some embodiments, including any of the foregoing, the cathode active is selected from the group consisting of lithium iron phosphate, lithium manganese iron phosphate, and combinations thereof. In some embodiments, the cathode active material is lithium iron phosphate. In some embodiments, the cathode active material is lithium manganese iron phosphate. In some embodiments, the cathode active material is a combination of lithium iron phosphate and lithium manganese iron phosphate.

In some embodiments, including any of the foregoing, the anode active material is graphite, silicon, and combinations thereof. In some embodiments, the anode active material is graphite. In some embodiments, the anode active material is silicon. In some embodiments, the anode active material is a combination of graphite and silicon.

In some embodiments, the electrochemical cell includes an electrolyte selected from the group consisting of a liquid electrolyte, a gel electrolyte, a solid-state electrolyte, and combinations thereof. In some embodiments, the electrolyte is a liquid electrolyte. In some embodiments, the electrolyte is a gel electrolyte. In some embodiments, the electrolyte is a solid-state electrolyte. In some embodiments, the electrolyte is a combination a liquid electrolyte, a gel electrolyte, and a solid-state electrolyte. In some embodiments, the electrolyte is a combination a liquid electrolyte and a gel electrolyte.

In some embodiments, the electrolyte is a combination a liquid electrolyte and a solid-state electrolyte. In some embodiments, the electrolyte is a combination a gel electrolyte and a solid-state electrolyte.

In some embodiments, including any of the foregoing, the active material loading in the at least one positive electrode is at least 50 mg/cm².

In some embodiments, including any of the foregoing, the electrochemical stack further includes a vent on at least one prismatic can face. In certain embodiments, the vent is between the positive terminal and the negative terminal. In certain embodiments, the vent is between the positive terminal and the negative terminal and on the same face as the positive terminal and the negative terminal.

In some embodiments, including any of the foregoing, the electrochemical stack has a capacity of at least 50 Ah. In certain embodiments, this capacity is at a C-rate of 1 C to 12 C. In some embodiments, the C-Rate is 1 C. In some embodiments, the C-Rate is 2 C. In some embodiments, the C-Rate is 3 C. In some embodiments, the C-Rate is 4 C. In some embodiments, the C-Rate is 5 C. In some embodiments, the C-Rate is 6 C. In some embodiments, the C-Rate is 7 C. In some embodiments, the C-Rate is 8 C. In some embodiments, the C-Rate is 9 C. In some embodiments, the C-Rate is 10 C. In some embodiments, the C-Rate is 11 C. In some embodiments, the C-Rate is 12 C. In some embodiments, capacity is achieved at −20° C. to 60° C. In some embodiments, capacity is achieved at −20° C. to 40° C. In some embodiments, capacity is achieved at −20° C. to 20° C. In some embodiments, capacity is achieved at −10° C. to 60° C. In some embodiments, capacity is achieved at 0° C. to 60° C. In some embodiments, capacity is achieved at 0° C. to 50° C. In some embodiments, capacity is achieved at −0° C. to 20° C. In some embodiments, including any of the foregoing, the electrochemical stack retains more than 90% of its discharge capacity after 1,000 cycles. In some embodiments, including any of the foregoing, the electrochemical stack retains more than 95% of its discharge capacity after 1,000 cycles. In some embodiments, including any of the foregoing, the electrochemical stack retains more than 99% of its discharge capacity after 1,000 cycles.

### Modules and Packs

In some embodiments, set forth herein is module or pack that includes at least one electrochemical stack in a prismatic can described herein.

### Process for Using

In some embodiments, set forth herein is a method of using an electrochemical stack described herein, or a module or pack described herein, including charging the electrochemical stack to at least 4.1 V.

In some embodiments, including any of the foregoing, the method includes charging the electrochemical stack to at least 4.2V, 4.3V, 4.4V, or 4.5V.

In some embodiments, set forth herein is a method of using an electrochemical stack described herein, or a module or pack described herein, including charging the electrochemical stack, module, or pack, to less than 4.5 V.

In some embodiments, including any of the foregoing, the method includes charging the electrochemical stack to less than 4.4V, 4.3V, 4.2V, or 4.1 V.

In some embodiments, including any of the foregoing, the method includes charging or discharging the electrochemical stack at 0.5 C, 1 C, 2 C, 3 C, or 5 C rate.

In some embodiments, including any of the foregoing, the method includes charging or discharging occurs at −10° C., 0° C., 23° C., 45° C., or 60° C.

### Examples

Cycling instruments included a Think-Power (Taiwan).

LFP was acquired from QingHai TuiHai New Material. LMFP was acquired from Skyland. PVDF was acquired from Kureha. MG11 was acquired from China Steel Chemical.

Super-P was acquired from Timcal. VGCF-H was acquired from Showa. Reagents, chemicals, and materials were commercially purchased unless specified otherwise.

Below, the acronym, P6, refers to LMFP64. The acronym, S, refers to Super-P. The acronym, V, refers to VGCF. The acronym, 73, refers to PVDF7300. The acronym, MG11, refers to graphite.

### Example 1—Making Large Format LFP and LFMP Cells

Cathode electrode preparation. Five separate slurries were made that each included 94% by weight (wt %) LFP or LMFP. The weight ratio of LFP, LMFP, or a combination thereof, was as is set forth in Table 1 for Test Electrochemical Cells I, II, III, IV, and V. In addition, each slurry included 1 wt % vapor-grown carbon fiber (VGCF), 2 wt % Super-P, and 3 wt % polyvinylidenefluoride (PVDF). Super-P is a carbon black powder for Li cathodes available for purchase from Imerys at https://www.imerys.com/product-ranges/super-p-li.

The PVDF was dissolved in N-methyl pyrrolidone (NMP), and then VGCF, Super-P, and powder including LFP and/or LMFP, according to Table 1, were added to the solution. The resulting slurry was stirred for 6 hours.

The slurry was then coated on both sides of an aluminum (AI) foil and dried at 80° C. under vacuum for 12 hours.

The cathode active material weight loading was 0.013 g/cm². Five samples I, II, III, IV, and V were made, one for each Test Electrochemical Cells I, II, III, IV, and V, further described below.

TABLE 1
Weight Ratio of LFP:PMFP64 in Cathodes in Test
Electrochemical Cells I, II, III, IV, and V

| Weight Ratio | I | II | III | IV | V |
|---|---|---|---|---|---|
| LFP | 0 | 30 | 50 | 70 | 100 |
| LMFP64 | 100 | 70 | 50 | 30 | 0 |

Anode electrode preparation. An anode slurry was made that included 95 wt % graphite, 1 wt % VGCF, 1 wt % Super-P and 3 wt % PVDF.

The PVDF was dissolved in N-methyl pyrrolidone (NMP), and then VGCF, Super-P, and graphite powder were added to the solution. The resulting slurry was stirred for 6 hours.

The slurry was then coated on both sides of a copper (Cu) foil and dried at 70° C. under vacuum for 12 hours.

The weight loading of graphite was 0.006 g/cm². Test Electrochemical Cells I, II, III, IV, and V were made using the same anode slurry individually paired with each of the above five cathode slurries.

Separator and electrolyte. A porous polypropylene separator having a thickness of 16 μm was used. A 1 molar (M) solution of LiFP₆ in ethylene carbonate/ethylmethylcarbonate/diethyl carbonate (EC/EMC/DEC) was used as the separator and electrolyte.

The separator and electrolyte were sandwiched between the Al foil coated on both sides with the cathode active slurry, and the Cu foil coated on both sides with the anode active slurry. This formed a one layer electrochemical cell.

### Full Cell Samples:

Test sample 18650 cylindrical cells were assembled using the above components and by rolling multiple layers of electrochemical cells together.

### Example 2—Testing Large Format LFP Cells

Electrochemical testing. Test cells were electrochemically cycled between 2V and 3.6V at 1 C rate.

Different lower cut-off charge voltages were also analyzed to determine which provided a preferred cycle performance. The different lower cut-off charge voltages analyzed were 4.1V, 4.2V, 4.3V, 4.4V and 4.5V. The test cells were held at the analyzed, constant voltage for 1 hour.

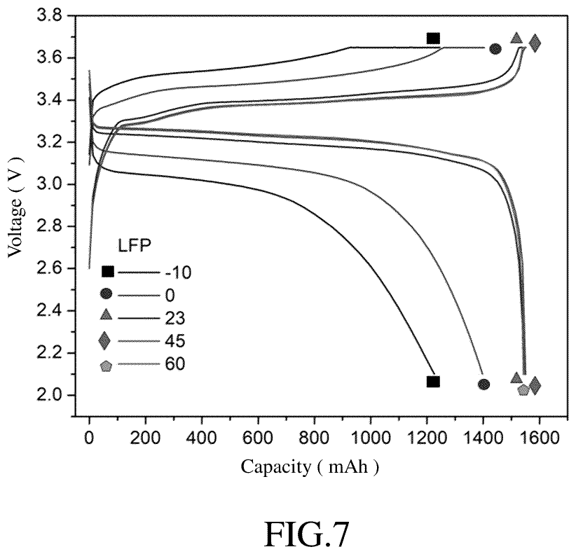

FIG. 7 shows the performance of Test Electrochemical Cell V (100% of the active material was LFP), which was tested at −10° C., 0° C., 23° C., 45° C., and 60° C. The test cell was a jelly-roll, 18650 cell type.

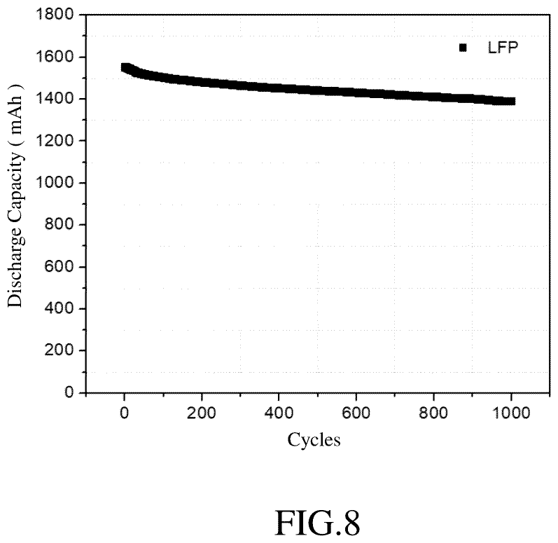

FIG. 8 shows a plot of Discharge Capacity (mAh) as a function of charge-discharge cycle. The plot shows surprisingly that the Discharge Capacity remained relatively constant for 1,000 cycles. Initially, the Discharge Capacity was about 1,550 mAh and remained at 1,400 after 1,000 cycles.

### Example 3—Testing Large Format LMFP Cells

Electrochemical testing. Test cells were electrochemically cycled between 2V and 3.6V at 1 C rate.

Different lower cut-off charge voltages were also analyzed to determine which provided a preferred cycle performance. The different lower cut-off charge voltages analyzed were 4.1V, 4.2V, 4.3V, 4.4V and 4.5V. The test cells were held at the analyzed, constant voltage for 1 hour.

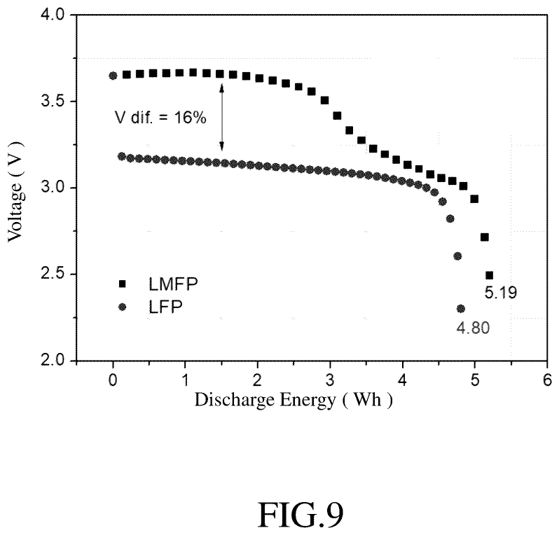

FIG. 9 shows a plot of Voltage (V) as a function of Discharge Energy (Wh) for Test Electrochemical Cell I (100% of the active material was LMFP; top plot) with comparison to Test Electrochemical Cell V (100% of the active material was LFP; bottom plot).

The comparison of discharge energy of LFP with LMFP at 1 C showed that the LFP was 4.80 Wh and LMFP was 5.19 Wh.

### Example 4—Testing Large Format LMFP Cells

Sample P-001 included LMFP64 as the cathode active material, at 12.5 mg/cm² cathode active material loading, and included binders and additives P6, S, V, and 72 at a weight ratio of (P6):(S):(V):(72) of 94:1:2:3. The anode included MG11 as the anode active material, at 5.7 mg/cm² anode active material loading, and included binders and additives MG11, S, V, and 73 at a weight ratio of (P6):(S):(V):(72) of 95:1:1:3.

Sample P-002 included LMFP64 as the cathode active material, at 13.0 mg/cm² cathode active material loading, and included binders and additives P6, S, V, and 72 at a weight ratio of (P6):(S):(V):(72) of 94:1:2:3. The anode included MG11 as the anode active material, at 6.0 mg/cm² anode active material loading, and included binders and additives MG11, S, V, and 73 at a weight ratio of (MG11):(S):(V):(73) of 95:1:1:3.

Electrochemical testing. Test cells were electrochemically cycled to a maximum voltage of either 4.2 V or 4.5 V, at 1 C rate.

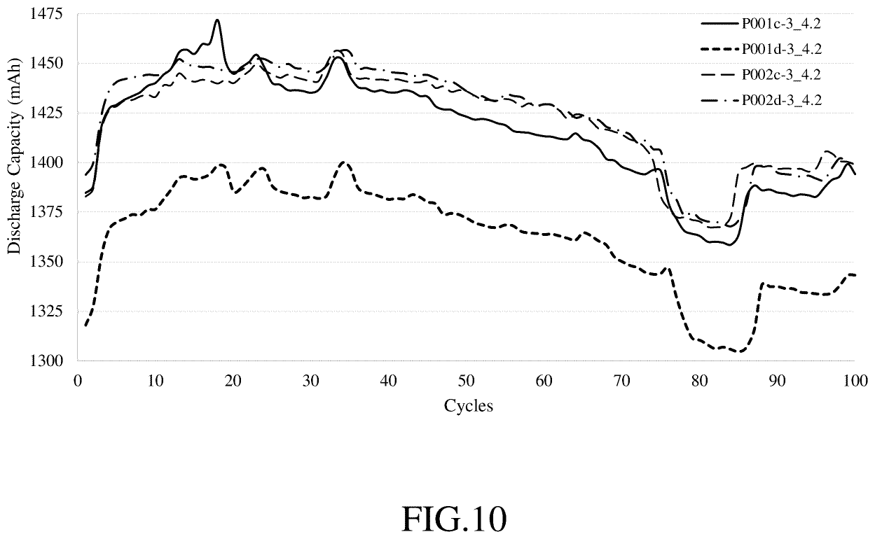

FIG. 10 shows a plot of Discharge Capacity (mAh) as a function of charge-discharge cycle for electrochemical cells that were charged to a maximum of 4.2 V.

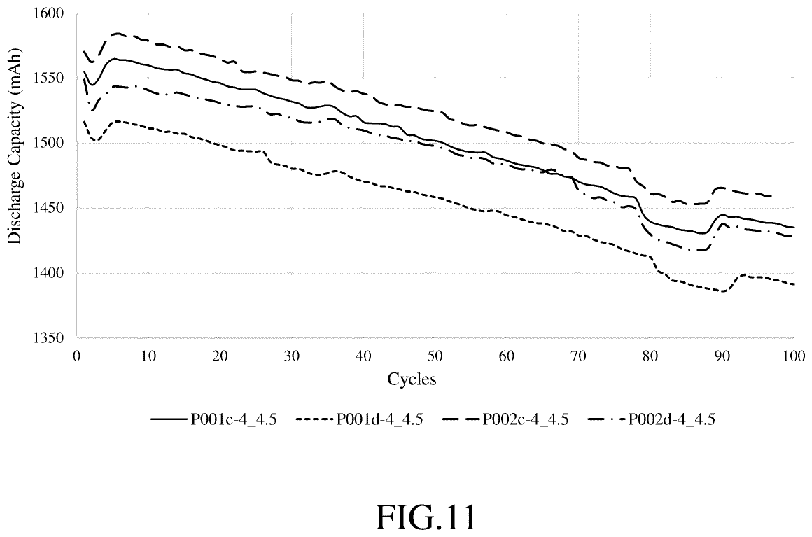

FIG. 11 shows a plot of Discharge Capacity (mAh) as a function of charge-discharge cycle for electrochemical cells that were charged to a maximum of 4.5 V.

This Example shows that the higher charging voltage are associated with higher discharge capacity. Herein, the discharge capacity observed for charging to 4.5V was higher than the discharge capacity observed for charging to 4.2V.

The higher capacity decay was observed on the electrochemical cells that were charged to a maximum voltage of 4.5V.

Table 2 below shows discharge capacity (mAh) for test electrochemical cells that were charged to a maximum voltage of either 4.2V or 4.5V.

TABLE 2

| | P001c | P001d | P002c | P002d |
|---|---|---|---|---|
| 4.2 V | 1427 | 1366 | 1426 | 1436 |
| 4.5 V | 1564, | 1516, | 1583, | 1543, |
| | +10% | +11% | +11% | +7% |

### Example 5—Testing Large Format LMFP Cells

Electrochemical testing. Test cells were electrochemically cycled between 2V and 3.6V at 1 C rate.

Different lower cut-off charge voltages were also analyzed to determine which provided a preferred cycle performance. The different lower cut-off charge voltages analyzed were 4.1V, 4.2V, 4.3V, 4.4V and 4.5V. The test cells were held at the analyzed, constant voltage for 1 hour.

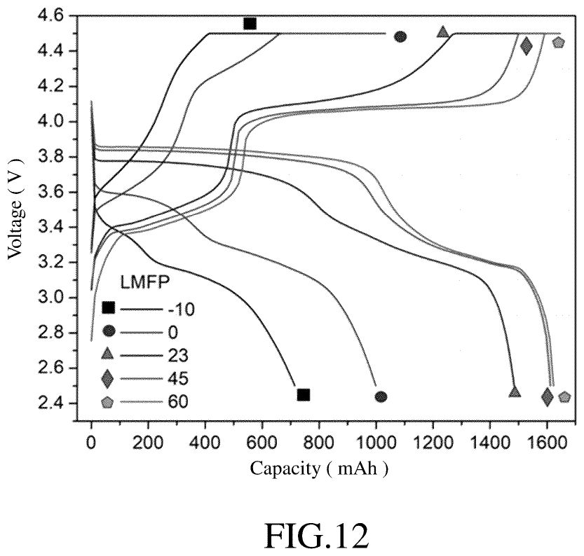

FIG. 12 shows the performance of Test Electrochemical Cell I (100% of the active material was LMFP), which was tested at −10° C., 0° C., 23° C., 45° C., and 60° C. The sample tested included LMFP64 as the cathode active material, at 12.5 mg/cm² active material loading, and included binders and additives P6, S, V, and 72 at a weight ratio of (P6):(S):(V):(72) of 93.5:1:2:3.5. The anode included MG11 as the anode active material, at 5.7 mg/cm² anode active material loading, and included binders and additives MG11, S, V, and 73 at a weight ratio of (MG11):(S):(V):(73) of 95:1:1:3. The test cell was a jelly-roll, 18650 cell type.

Charge and discharge curves of LMFP64 under different temperature at −10° C., 0° C., 23° C., 45° C. and 60° C. at 1 C rate.

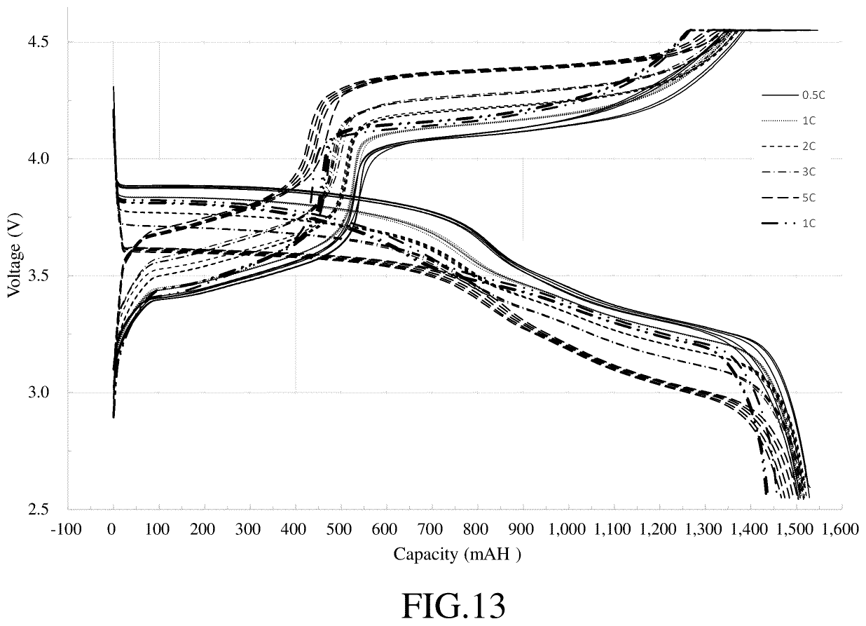

FIG. 13 shows the Rate Capability performance of Test Electrochemical Cell I (100% of the active material was LMFP), LMFP64 at 0.5 C, 1 C, 2 C, 3 C, 5 C and 1 C. The sample tested included LMFP64 as the cathode active material, at 12.5 mg/cm² loading, and included binders and additives P6, S, V, and 72 at a weight ratio of (P6):(S):(V):(72) of 94:1:2:3 weight ratios respectively. The anode included MG11 as the anode active material, at 5.7 mg/cm² loading, and included binders and additives MG11, S, V, and 73 at a weight ratio of (MG11):(S):(V):(73) of 95:1:1:3. The test cell was a jelly-roll, 18650 cell type.

Table 3 shows the Rate Capability results of LMFP64 at 0.5 C, 1 C, 2 C, 3 C, 5 C and 1 C.

TABLE 3
P-001d, Nominal voltage changed with the different rate

| | | | |
|---|---|---|---|
| | Discharge | Energy | Nominal |
| Rate | Capacity (mAh) | (Wh) | Voltage (V) |

| | | | | |
|---|---|---|---|---|
| 0.5 | C | 1528.27 | 5.43 | 3.55 |
| 1 | C | 1506.17 | 5.26 | 3.49 |
| 2 | C | 1517.34 | 5.21 | 3.43 |
| 3 | C | 1509.66 | 5.10 | 3.38 |
| 5 | C | 1484.55 | 4.90 | 3.30 |

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. An electrochemical stack in a prismatic can, wherein:
the electrochemical stack comprises at least one positive electrode that comprises lithium iron phosphate (LFP) active material, lithium manganese iron phosphate (LMFP) active material, or a combination thereof;
the prismatic can has a positive terminal and a negative terminal on at least one prismatic can face; and
the surface area of the positive terminal and the negative terminal is at least 70% of the surface area of the at least one prismatic can face.

2. The electrochemical stack of claim 1, wherein the LFP has the formula LiFe₁₋ₓMnₓPO₄, wherein x is 0.1 to 0.9.

3. The electrochemical stack of claim 1, wherein the at least one positive electrode comprises LMFP active material selected from LMFP64, LMFP82, or a combination thereof.

4. The electrochemical stack of claim 1, wherein the combination of LFP active material and LMFP active material has a weight ratio of LFP:LMFP that is 0.01:100 to 100:0.01.

5. The electrochemical stack of claim 1, wherein the positive terminal and the negative terminal are on the same prismatic can face.

6. The electrochemical stack of claim 5, wherein the positive terminal and the negative terminal are on the top prismatic can face or the bottom prismatic can face, or equivalently wherein the positive terminal and the negative terminal are on opposite major faces.

7. The electrochemical stack of claim 5, wherein the positive terminal is on the top major face and the negative terminal is on the bottom major face.

8. The electrochemical stack of claim 5, wherein the positive terminal and the negative terminal are on a minor face.

9. The electrochemical stack of claim 8, wherein the positive terminal and the negative terminal are on a different minor face.

10. The electrochemical stack of claim 8, wherein the positive terminal and the negative terminal are on different edge prismatic can faces.

11. The electrochemical stack of claim 8, wherein the positive terminal and the negative terminal are on opposite, parallel faces.

12. The electrochemical stack of claim 1, wherein the prismatic can height (or length) is at least 80 cm.

13. The electrochemical stack of claim 1, wherein the prismatic can width is at least 25 cm.

14. The electrochemical stack of claim 1, wherein the prismatic can thickness is at least 2 cm.

15. The electrochemical stack of claim 1, wherein the electrochemical stack comprises at least one negative electrode selected from the group consisting of a graphite anode, a silicon anode, and graphite-silicon anode.

16. The electrochemical stack of claim 1, wherein the electrochemical stack comprises at least one aluminum positive electrode current collector.

17. The electrochemical stack of claim 1, wherein the electrochemical stack comprises at least one negative electrode current collector selected from a copper (Cu) current collector, a nickel (Ni) current collector, and a current collector comprising combinations or alloys of Cu, Ni, or Cu and Ni.

18. The electrochemical stack of claim 1, wherein the electrochemical stack comprises at least one electrolyte selected from the group consisting of a liquid electrolyte, a gel electrolyte, a solid-state electrolyte, and combinations thereof.

19. The electrochemical stack of claim 1, wherein the at least one positive electrode, the at least one negative electrode, or both further comprises about 4 wt % to 6 wt % binders and carbon additives.

20. The electrochemical stack of claim 1, wherein the electrochemical stack comprises at least twenty layers.

21. The electrochemical stack of claim 1, wherein the electrochemical stack comprises 100 layers or less.

22. The electrochemical stack of claim 21, wherein the layers are configured in a zig-zag format, a layered stack format, or a rolling format.

23. The electrochemical stack claim 1, wherein the active material loading in the at least one positive electrode is at least 5 mg/cm².

24. The electrochemical stack of claim 1, further comprising a vent on at least one prismatic can face.

25. The electrochemical stack of claim 1, wherein the electrochemical stack has a capacity of at least 50 Ah.

26. The electrochemical stack of claim 1, wherein the electrochemical stack retains more than 90% of its discharge capacity after 1,000 cycles.

27. A cell pack comprising at least one electrochemical stack in a prismatic can of claim 1.

28. A method of using the electrochemical stack of claim 1, comprising charging the electrochemical stack to at least 4.1 V or to less than 4.5 V.

29. The method of claim 28, further comprising charging or discharging the electrochemical stack at 0.5 C, 1 C, 2 C, 3 C, or 5 C rate.

30. The method of claim 29, wherein the charging or discharging occurs at −10° C., 0° C., 23° C., 45° C., or 60° C.

31. A method of using the cell pack of claim 27, comprising charging the cell pack to at least 4.1 V or to less than 4.5 V.

32. The method of claim 31, further comprising charging or discharging the cell pack at 0.5 C, 1 C, 2 C, 3 C, or 5 C rate.

33. The method of claim 32, wherein the charging or discharging occurs at −10° C., 0° C., 23° C., 45° C., or 60° C.
